(19) United States
(12) Patent Application Publication
(10) Pub. No.: US 2014/0210252 A1
(43) Pub. Date: Jul. 31, 2014

(54) SPOKE NIPPLE STRUCTURE FOR REDUCING RUPTURE OF SPOKE THREAD

(71) Applicant: Wen Hsuan Chen, New Taipei City (TW)

(72) Inventor: Wen Hsuan Chen, New Taipei City (TW)

(21) Appl. No.: 13/751,132

(22) Filed: Jan. 27, 2013

(51) Int. Cl. B60B 1/02

(52) U.S. Cl. CPC B60B 1/0261
USPC 301/104

(57) ABSTRACT

Spoke nipple structure for reducing rupture of spoke thread, which could maintain the straightness of the spoke thread by improving spoke and mated nipple; the spoke comprises: a spoke body as well as head and threaded portion set separately at both ends of the spoke body; the head is pulled or bent in practice to mate with the hub, and the threaded portion is provided with a threaded section of certain length; especially, a cyclic bulge is shaped on the spoke body adjacent to the threaded portion; the max. OD of the bulge is less than or equal to the ID of the nipple's large hole for tight coupling; the locking effect of cyclic bulge could maintain the straightness of the threaded portion and eliminate the bending point formed in the threaded portion of spoke arising from the transversal stress.

### BACKGROUND OF INVENTION

1. Field of the Invention

The present invention relates generally to a combined structure of spoke nipple, and more particularly to a spoke nipple structure which is applied to bicycles and motorcycles for reducing the rupture of spoke thread.

2. Description of Related Art

Wheel sets of motorcycles or bicycles generally comprise a hub, spoke and rim. Referring to FIG. 1, a spoke 1 comprises a spoke body 11 as well as head 12 and threaded portion 13 set separately at both ends of the spoke body 11; said nipple 2 comprises a nipple body 21 as well as a large hole 22 and a small hole 23 formed and interconnected at two hollow ends inside the nipple body 21; a threaded section 231 is set inside the small hole 23. Besides, due to various designs of the hub and consideration of offset angle of rim nipple hole as well as different cross-weaving of spoke, a bevel or bending point I, after assembly of the wheels, will be formed under stress H at the threaded portion end of spoke, as shown in FIG. 2.

When a user rides a motorcycle or bicycle, rupture of the above-mentioned threaded portion may occur due to continued extension and compression of spoke under the vehicle's load and speed. When analyzing the rupture surface, it's found that the rupture is directional, and often occurs in the first thread (namely the bending point I formed by transversal stress H in FIG. 2).

Thus, to overcome the aforementioned problems of the prior art, it would be an advancement if the art to provide an improved structure that can significantly improve the efficacy.

Therefore, the inventor has provided the present invention of practicability after deliberate design and evaluation based on years of experience in the production, development and design of related products.

### SUMMARY OF THE INVENTION

In view of said problems, a spoke nipple structure for reducing rupture of spoke thread is provided in the present invention to keep the straightness of the spoke threaded portion and prevent it from being bent by the spoke's weaving angle in the rim, thus protecting the vertical threaded portion against fatigue and rupture under transversal stress.

The following technical scheme of the present invention comprises of the following contents:

1. Improve the spoke structure by the processing method:

For improvement of existing spoke, the spoke structure comprises: a spoke body, a head and threaded portion formed at both ends of the spoke body; the head is used for mating with the hub and the threaded portion is provided with a threaded section of certain length, especially, a cyclic bulge is shaped on the spoke body adjacent to the threaded portion; the max. OD of the bulge is less than or equal to the ID of the nipple's large hole for tight coupling.

2. Improve the nipple structure by the processing method:

While the conventional spoke structure is kept unchanged, the improved nipple structure comprises: a nipple body as well as a large hole and a small hole formed and interconnected at two hollow ends inside the nipple body; a non-threaded section is set into ID of the large hole and a threaded section into ID of the small hole. In particular, a shallow threaded section is additionally set onto non-threaded section in the large hole's ID, allowing for screw-in of threaded portion contained in the spoke body; and the female thread diameter of the shallow threaded section is larger than or equal to the spoke body's diameter, enabling tight coupling of the spoke and nipple by screwing the shallow threaded section into the spoke body and threaded portion.

Furthermore, a reduced end or a beveled end structure can be formed at the end of the threaded portion, for the smooth mating of the spoke and the shallow threaded section in the ID of nipple's large hole.

3. Improve the nipple structure by the processing method:

While the conventional spoke structure is still kept unchanged, the improved nipple structure comprises: a nipple body as well as a large hole and a small hole formed and interconnected at two hollow ends inside the nipple body; a non-threaded section is set into ID of the large hole and a threaded section into ID of the small hole. In particular, a shallow threaded section is additionally set between the threaded sections of large and small holes, allowing for screw-in of threaded portion contained in the spoke body; and the female thread diameter of the shallow threaded section is larger than or equal to the spoke body's diameter, enabling tight coupling of the spoke body and nipple by screwing the shallow threaded section into the spoke body and threaded portion.

The present invention will be more readily understood with reference to the accompanying drawings and preferred embodiment.

### BRIEF DESCRIPTION OF THE DRAWINGS

FIG. 1: a structural view of conventional spoke and nipple.

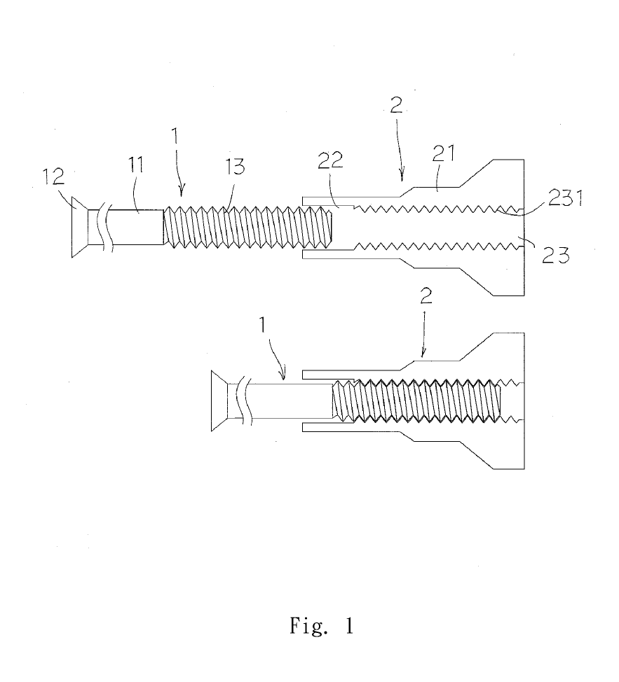

FIG. 2: a rupture view of conventional spoke and nipple structure.

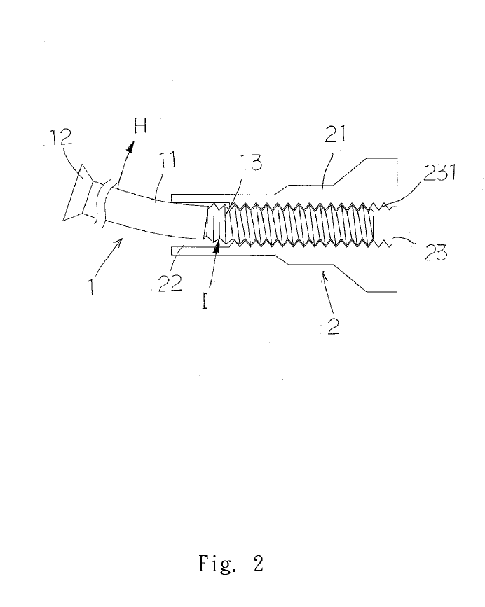

FIG. 3: a structural view of the first embodiment of the present invention.

FIG. 4: a rupture view of spoke and nipple structure based on FIG. 3.

FIG. 5: a structural view of the second embodiment of the present invention.

FIG. 6: a rupture view of spoke and nipple structure based on FIG. 5.

FIG. 7: a structural view of the third embodiment of the present invention.

FIG. 8: a rupture view of spoke and nipple structure based on FIG. 7.

### DETAILED DESCRIPTION OF THE INVENTION

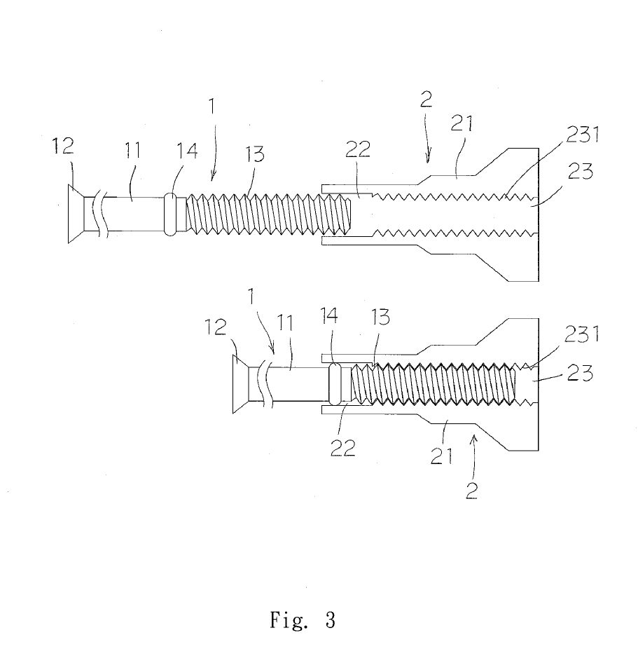

Firstly, referring to FIG. 3, a spoke nipple structure for reducing rupture of spoke thread is provided in present invention, wherein the spoke 1 comprises: a spoke body 11, as well as head 12 and threaded portion 13 set separately at both ends of the spoke body 11; the head 12 is pulled or bent in practice to mate with the hub; and the threaded portion 13 is provided with a threaded section of certain length; especially, a cyclic bulge 14 is shaped on the spoke body 11 adjacent to the threaded portion 13; the max. OD of the bulge 14 is less than or equal to the ID of the nipple's large hole 22 for tight coupling.

Said nipple 2 comprises: a nipple body 21 as well as a large hole 22 and a small hole 23 formed and interconnected at two hollow ends inside the nipple body 21; a non-threaded section is set into ID of the large hole 22 and a threaded section 231 into ID of the small hole 23.

During assembly, the threaded portion 13 of spoke body 11 is screwed from the large hole 22 of nipple body 21, such that the cyclic bulge 14 is also screwed tightly onto non-threaded section in the large hole 22.

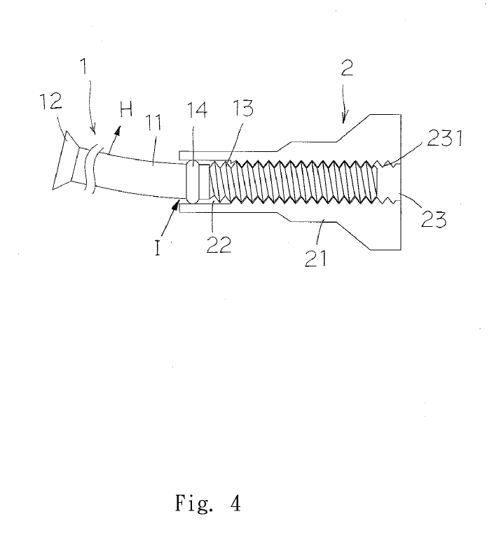

Referring also to FIG. 4, based on the assembled structure of aforementioned spoke 1 and nipple 2, it's found that the threaded portion 13 and cyclic bulge 14 of the spoke 1 are completely covered by the nipple 2, thus, the locking effect of cyclic bulge 14 could maintain the straightness of the threaded portion 13 while eliminating the bending point I formed in the threaded portion 13 of spoke 1 arising from the transversal stress H; in such case, the bending point I under transversal stress H is guided to the spoke body 11 nearby relatively robust cyclic bulge 14 from weak threaded portion 13. With this improvement, the threaded portion 13 of spoke 1 is not bent due to the spoke's weaving angle assembled onto the rim, helping to protect the vertical threaded portion 13 against fatigue and rupture under transversal stress.

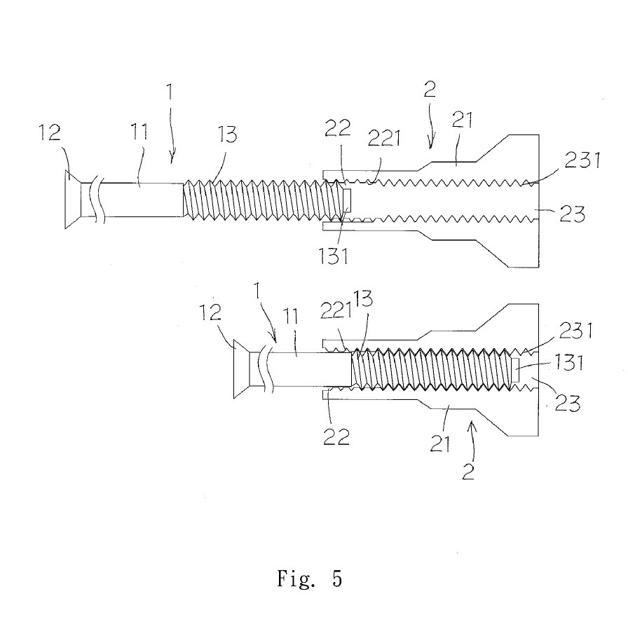

Referring also to FIG. 5, another preferred embodiment of the spoke nipple structure for reducing rupture of spoke thread is provided in present invention, wherein the spoke 1 comprises: a spoke body 11, a head 12 and a threaded portion 13 formed at both ends of the spoke body 11; the head 12 is pulled or bent in practice to mate with the hub and the threaded portion 13 is provided with a threaded section of certain length.

Said nipple 2 comprises: a nipple body 21 as well as a large hole 22 and a small hole 23 formed and interconnected at two hollow ends inside the nipple body 21; a non-threaded section is set into ID of the large hole 22 and a threaded section 231 into ID of the small hole 23. In particular, a shallow threaded section 221 is additionally set onto non-threaded section in the large hole's ID, allowing for screw-in of threaded portion 13 contained in the spoke body 11; and the female thread diameter of the shallow threaded section 221 is larger than or equal to the spoke body's diameter, enabling tight coupling of the spoke 1 and nipple 2 by screwing the shallow threaded section into the spoke body 11 and threaded portion 13.

During assembly, the threaded portion 13 of spoke body 11 is screwed into the large hole 22 of the nipple body 21; with the shallow threaded section 221 formed in the large hole 22 of non-threaded section of the nipple 2, the threaded portion 13 of spoke 1 could be screwed into the nipple 2 along with the threaded section 231 and shallow threaded section 221 for tight coupling.

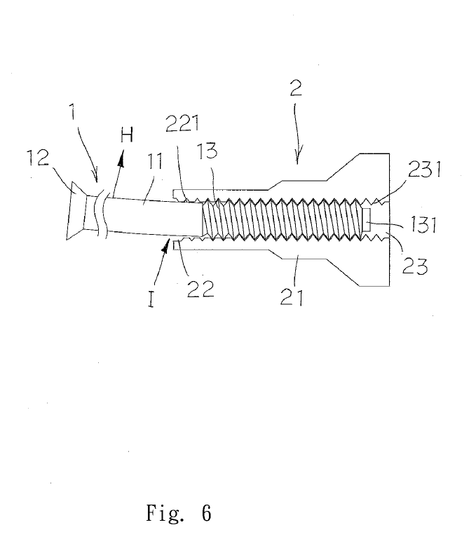

Referring to FIG. 6, based on the assembled structure of aforementioned spoke 1 and nipple 2, the threaded portion 13 of the nipple 1 is fully screwed in the shallow threaded section 221 of large hole 22 and threaded section 231 of small hole 23 of the nipple 2; thus, the locking effect of shallow threaded section 221 could maintain the straightness of the threaded portion 13, while the bending point I under transversal stress H is guided to the relatively robust spoke body 11 from weak threaded portion 13. With this improvement, the threaded portion 13 of spoke 1 is not bent due to the spoke's weaving angle assembled onto the rim, helping to protect the vertical threaded portion 13 against fatigue and rupture under transversal stress H.

According to aforementioned improvement of said nipple 2, smooth large hole of conventional nipple is modified into a large hole 22 with shallow threaded section 221, however, this increases the difficulty in assembly of the spoke 1 and nipple 2; in order to mate the flange of threaded portion 13 of the spoke 1 with the large hole 22 of the nipple 2 smoothly, a reduced end or a lead angle end structure 131 can be further formed at the end of the threaded portion 13 for quick and smooth assembly.

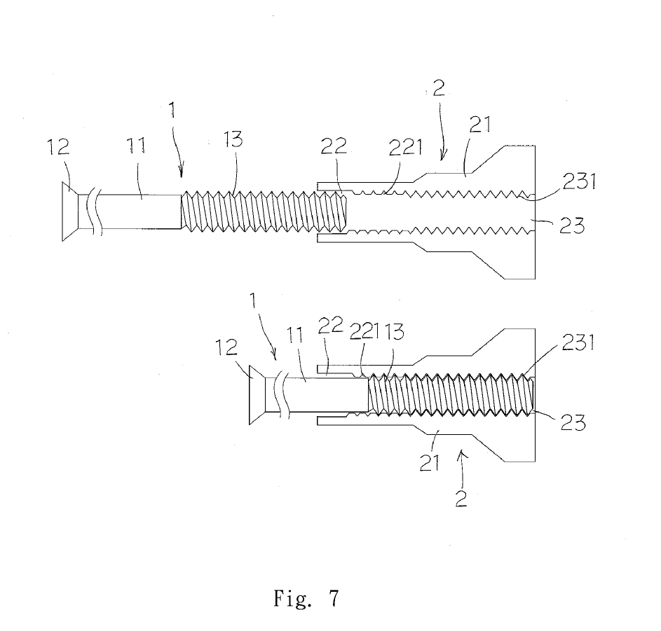

Referring also to FIG. 7, another preferred embodiment of the spoke nipple structure for reducing rupture of spoke thread is provided in present invention, wherein the spoke 1 also comprises: a spoke body 11, a head 12 and a threaded portion 13 formed at both ends of the spoke body 11; the head 12 is pulled or bent in practice to mate with the hub and the threaded portion 13 is provided with a threaded section of certain length.

Said nipple 2 comprises: a nipple body 21 as well as a large hole 22 and a small hole 23 formed and interconnected at two hollow ends inside the nipple body 21; a non-threaded section is set into ID of the large hole 22 and a threaded section 231 into ID of the small hole 23. In particular, a shallow threaded section 221 is additionally set between the large hole 22 of the nipple 2 and threaded section 231 of the small hole 23, allowing for screw-in of threaded portion 13 contained in the spoke body 11; and the female thread diameter of the shallow threaded section 221 is larger than or equal to the spoke body's diameter, enabling tight coupling of the spoke 1 and nipple 2 by screwing the shallow threaded section into the spoke body 11 and threaded portion 13.

During assembly, the threaded portion 13 of spoke body 11 is screwed into the large hole 22 of the nipple 2, and then the shallow threaded section 221 and threaded portion 13 screwed into the corresponding threaded section 231 of the nipple 2 for tight mating.

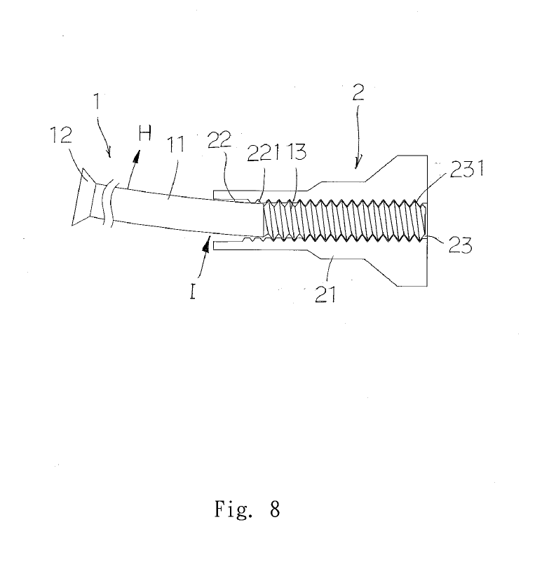

Referring also to FIG. 8, based on the assembled structure of aforementioned spoke 1 and nipple 2, it's found clearly from the figure that the threaded portion 13 of the spoke 1 and a part of spoke body are completely screwed into non-threaded section and shallow threaded section 221 in the large hole 22 of the nipple 2, as well as the threaded section 231 in the small hole 23; as non-threaded section in the small hole 22 of the nipple 2 could reduce the difficulty of screw-in of the threaded portion 13 of the spoke 1, and the straightness of the threaded portion 13 could be guaranteed by the screwing of the shallow threaded section 221 and the threaded section 231; also, the bending point I under transversal stress H is guided to the relatively robust spoke body 11 from weak threaded portion 13. With this improvement, the threaded portion 13 of spoke 1 is not bent due to the spoke's weaving angle assembled onto the rim, helping to protect the vertical threaded portion 13 against fatigue and rupture under transversal stress H.

To sum up, the present invention of spoke nipple structure for reducing rupture of spoke thread could better protect the spoke and nipple complying with the spirit of new patents, so the patent claims are made hereto.

Although the invention has been explained in relation to its preferred embodiment, it is to be understood that many other possible modifications and variations can be made without departing from the spirit and scope of the invention as hereinafter claimed.

1. A spoke nipple structure for reducing rupture of spoke thread, which comprising: a spoke and a mated nipple; said spoke comprises: a spoke body as well as head and threaded portion set separately at both ends of the spoke body; said head is used to mate with the hub, and the threaded portion is provided with a threaded section of certain length; a cyclic bulge is shaped on the spoke body adjacent to the threaded portion for tight mating with the nipple.

2. The spoke nipple structure for reducing rupture of spoke thread as claimed in claim 1, wherein the mated nipple comprises: a nipple body as well as a large hole and a small hole formed and interconnected at two hollow ends inside the nipple body; a non-threaded section is set into ID of the large hole and a threaded section into ID of the small hole, so the max. OD of the bulge is less than or equal to the ID of the nipple's large hole.

3. The spoke nipple structure for reducing rupture of spoke thread as claimed in claim 2, wherein a shallow threaded section is additionally set onto non-threaded section in the large hole's ID.

4. The spoke nipple structure for reducing rupture of spoke thread as claimed in claim 3, wherein the shallow threaded section in the large hole of the nipple allows for screw-in of threaded portion contained in the spoke body; and the female thread diameter of the shallow threaded section is larger than or equal to the spoke body's diameter.

5. The spoke nipple structure for reducing rupture of spoke thread as claimed in claim 3, wherein a reduced end structure could be formed at the end of threaded portion by the nipple.

6. The spoke nipple structure for reducing rupture of spoke thread as claimed in claim 3, wherein a lead angle end structure could be formed at the end of threaded portion by the nipple.

7. The spoke nipple structure for reducing rupture of spoke thread as claimed in claim 2, wherein a shallow threaded section is additionally set between non-threaded section of large hole and threaded section of small hole of the nipple.

8. The spoke nipple structure for reducing rupture of spoke thread as claimed in claim 7, wherein the shallow threaded section between large and small holes of the nipple allows for screw-in of threaded portion contained in the spoke body; and the female thread diameter of the shallow threaded section is larger than or equal to the spoke body's diameter.
